(19) United States
(12) Patent Application Publication
(10) Pub. No.: US 2003/0171983 A1
(43) Pub. Date: Sep. 11, 2003

(54) Method for collection and collation of data

(76) Inventors: Bruce H D Reeves, Lower Hutt (NZ); Catherine R Davies, Lower Hutt (NZ)

Correspondence Address: ECKERT SEAMANS CHERIN & MELLOTT, 600 GRANT STREET, 44TH FLOOR, PITTSBURGH, PA, 15219

(21) Appl. No.: 10/343,598

(22) PCT Filed: Oct. 26, 2001
(86) PCT No.: PCT/NZ01/00238

(30) Foreign Application Priority Data
Nov. 27, 2000 (NZ) 508465
Apr. 27, 2001 (NZ) 511392
Jul. 11, 2001 (NZ) 512918

(51) Int. Cl. G06F 17/60

(52) U.S. Cl. 705/12

(57) ABSTRACT

The invention provides a method of collecting and collating data including the steps of: a) providing each user with an option or question paper where each option or question has a unique transmittable signal or code; b) assigning each user with a unique transmittable signal or code; c) assigning each user a specified address for receiving information to be transmitted by the user by any telecommunications means, or any other means for the transmitting and/or receiving of any signal or code; d) instructing the user to connect to the said specified address and enter the user signal or code, and signal or code or signals or codes for the selected options or questions (the data); e) receiving the entered user data; and f) processing and/or collating some or all of the user data. A computerised data processor is preferably used for receiving and processing the data. The method is particularly suitable for conducting an election, and the preferred telecommunication means is the telephone. Preferably voter identity checks and checks for multiple voting are provided for.

### FIELD OF INVENTION

This invention relates to a method for the collection and subsequent collation of information, and in particular relates to a method for the collection and collation of information from individuals or collectives and conveyed by way of a telecommunications link to a specified receiving address in such as a census, a survey, a referendum, an election or the like.

### BACKGROUND

It is well-known that situations arise where it becomes necessary to receive information from a number of individuals or collectives, and where it is desirable for that information to be efficiently collated for the purpose of achieving a result, or some statistical knowledge. For example, it is the practise of many governments to conduct a census of the citizens of their country for the purposes of planning for the future. Referenda are often conducted by governments or organisations and it is well-known to survey a sample of the population by way of polls and the like to obtain a consensus of opinion.

One of the most important events in any country is the conduction of a general election to determine the government for the country, and in most countries and communities the need to elect representatives at all levels of governance is a regular occurrence. Election of representatives, especially at government level, requires receiving and counting the votes of all eligible citizens, and can be an enormous exercise in logistics with respect to providing the means for the votes to be made, and subsequently collating, counting and recording the results of the voters' preferences.

In addition, any voting process, referendum, census, survey or the like, must usually be organised in such a way that it is open, yet secure, and ensures the secrecy of the recorded information. A means should be incorporated for detecting and invalidating the votes of voters who attempt to vote more than once. Usually, in an election, the progress of the results should not be available until such time as the ballot has closed and voting is complete. However, thereafter it is desirable that a count can be completed as rapidly and accurately as possible.

The process of voting, to date, usually requires voters to attend at designated voting sites, where votes are recorded by way of marking each voter's preference(s) on a prepared voting card or sheet. Prior to the vote being made the voter is identified on an electoral roll, and if that voter attempts to make a second vote this can be traced and the votes consequently invalidated. The cards or sheets are then collected and counted after the ballot has ended. Alternatively voters may be posted ballot papers for completion and return by mail. The tasks of vote counting, and voter identification are laborious and expensive, and are not as accurate as is desirable.

In addition, many votes are not recorded because voters cannot or do not, for a variety of reasons, make their way to the designated voting sites, in spite of the fact that in any election it is always a priority to maximise voter turn-out.

### OBJECT

It is an object of the present invention to address the foregoing identified problems, or at least to provide the public with a useful choice.

It is a further object of the invention to provide an improved method for collecting and collating data by way of a telecommunications link, or any other means for the transmitting or receiving of any signal or code, from individuals or collectives to a receiving address or central collecting agency in such as a census, a survey, a referendum, an election or the like.

It is a further object of the invention to provide a telecommunications system in association with a data processing system which is networked and adapted for use in the above improved method of collecting and collating data.

### STATEMENT OF INVENTION

According to a first aspect of the invention there is provided a method of collecting and collating data including the steps of:

a) providing each user with an option or question paper where each option or question has a unique transmittable signal or code;

b) assigning each user with a unique transmittable signal or code;

c) assigning each user a specified address for receiving information to be transmitted by the user by any telecommunications means, or any other means for the transmitting and/or receiving of any signal or code;

d) instructing the user to connect to the said specified address and enter the user signal or code, and signal or code or signals or codes for the selected options or questions (the data);

e) receiving the entered user data; and

f) processing and/or collating some or all of the user data.

According to a second aspect of the invention there is provided a method of voting including the steps of:

a) providing each voter with an option paper wherein each option has a unique transmittable signal or code;

b) assigning each voter a unique transmittable signal, code, or identifier;

c) assigning each voter a specified address for receiving information to be transmitted by the voter by any telecommunications means, or any other means for the transmitting and/or receiving of any signal or code;

d) instructing the voter to connect to the said specified address and enter the voter signal or code, and signal or code or signals or codes for the selected option or options (the data);

e) receiving the entered voter data; and

f) processing and/or collating some or all of the voter data.

Preferably each voter or user is additionally supplied with a unique transmittable PIN number which must be entered in addition to the unique voter transmittable signal or code.

Preferably the user or voter data is processed by a centralised computer data processing system.

Preferably the data processing system is enabled to generate a response on completion of the entry of data by the user or voter, to confirm that the data has been processed and the user or voter may now disconnect.

Preferably the data processing system is adapted to identify the incorrect matching of an entered PIN number with the user or voter unique transmittable signal or code, and to generate a response requesting the re-entry of the unique transmittable signal or code, and the PIN number.

Preferably the data processing system is adapted to recognise when a user or voter unique transmittable signal or code is entered more than once for the purposes of reentering selected options or voting more than once, and to invalidate all data entered at any time by that user or voter.

Preferably a summary of all, or selected portions of the received user or voter data is produced.

Preferably the user or voter signal or code, and the signal or code, or signals or codes for the selected option or options are entered such as to embrace the selection interactively, manually or via fixed or dynamically allocated means and processes;

Preferably the user or voter data and selected options are received and recorded manually, interactively, and/or via any automated process.

By specified address is meant any receiving address to which the user or voter may connect to transfer, by the appropriate telecommunication means, the user or voter signal, code or identifier, and signals or codes for the selected option or options, and if required, the unique transmittable PIN number.

In one embodiment of the invention the telecommunication means is a telephone and the specified address is a telephone number.

In another embodiment of the invention the telecommunication means is the internet by way of computer, internet enabled phone or interactive TV access, and the specified address is an email address, or website or other suitable receiving site.

In another embodiment of the invention the telecommunication means is networking-enabled phones and the specified address is a unique address made available by the service provider.

In another embodiment of the invention the telecommunications means is a voice activated computer enabled to communicate the voice activated selected option to the specified receiving address which may be an email address, website or other suitable receiving site.

It will be appreciated that while the above known means of telecommunication have been provided by way of example, that any means which enables data to be entered at one location for telecommunication to a receiving address is envisaged as within the scope of the invention. It will be further appreciated that as technology advances other suitable telecommunications means may be developed including any method for the transmitting or receiving of any signal or code. The method of the invention is not to be limited to only those telecommunication means presently available, but is intended to encompass any and all appropriate and relevant advances in technology.

It is envisaged for example that included within the scope of the invention are all card based applications, interactions and procedures via any communications method whatsoever. This includes magnetic swipe cards, smart cards, chip cards of any sort, transponders or any integrated circuit, RF circuit, micro-processor, stored memory, inducted loop process or technology, any transmitter or receiver process inclusive of bar code, infra-red or laser reader, writer or transmitter.

The means of communications transfer are envisaged as including existing fixed line telecommunications, mobile, cellular, satellite, microwave, radio frequency, or laser transmission or reception. Suitable mediums may include telephonic communications of any sort, copper, xDSL, ADSL, fibre optic, satellite of any sort, cards of any sort, card reader or writer, Point Of Sale (POS), kiosk, internet or personal data transmitter or receiver.

The process of data transmission is envisaged as including any circuit based or packet switching process of any kind.

It should also be appreciated that the method of this invention may be used in association with previously known methods of receiving and recording information, or previously known systems of voting, as, for example, in situations where a referendum, or election is conducted and where some of the users or voters do not have access to the telecommunications systems required to use the method of the invention.

In addition it should be appreciated that the method of the invention may incorporate the use of one, or any number of the above-mentioned means for the telecommunication of data in any one election, referendum, survey, census or the like.

While the following description of the invention specifically relates to voters in a general election it will be appreciated that this is by way of example only, and the method of the invention may similarly be applied to the responding by individual or collective users to other forms of survey or questionnaire such as those described above, and the method of the invention is not to be construed as limited to the recordal of votes in an election.

### EXAMPLE

In this example the method of the invention enables the individual voter to participate in an election from the privacy of their own homes, or any publicly available appropriate telecommunications system. The option for most voters to vote without having to leave home should have the desired effect of enhancing voter turn-out.

It will be appreciated that the uniquely specified addresses to which data is sent will be connected to a computer data processing system which has the appropriate software and hardware for receiving the data, collating, sorting and counting votes, and producing summary results as required. In addition the data processing system should preferably be enabled to generate a response to the voter after all the data has been entered to confirm that the data has been processed, and that the voter may disconnect.

The use of a voter signal or code unique to each voter can be readily used to identify any voters who attempt to vote more than once. It is a relatively simple matter, when information is received and processed electronically, to adapt systems to receive information from a signal or coded source once, and once only, and to thereafter extinguish that signal or code so that any subsequent information from that source could not be accepted. Furthermore, any first votes recorded from that source could also be cancelled, should a second attempt to vote by the same voter be detected.

Voter security in this example is guaranteed by way of the voter allocated PIN signal or code. Should any voter fail to supply the correct PIN signal or code allocated to its voter identifying signal or code, no vote would be allowed. Alternatively, if the voter code and PIN number do not match, then in a preferred embodiment of the example a response would be generated requesting that the voter re-enter the voter code and PIN number.

Should the laws of the nation or organisation conducting the election allow it, the data processing system of this example would enable progressive counting and reporting on the progress of the election, and as soon as the ballot closes the technology is available to enable an extremely rapid collation, count and reporting of the data received.

It will further be appreciated that the hardware and software for this kind of electronic processing does exist, and can be readily assembled by personnel skilled in this area of computing.

The preferred example of the invention will now be described by way of example only, in which the forms and instructions referred to are those of FIGS. 1, 2 and 3.

In this preferred example, preparatory to the voting each eligible voter will be posted an information package which includes:

the details of the election to take place;

an individual voting form, as shown in FIG. 1;

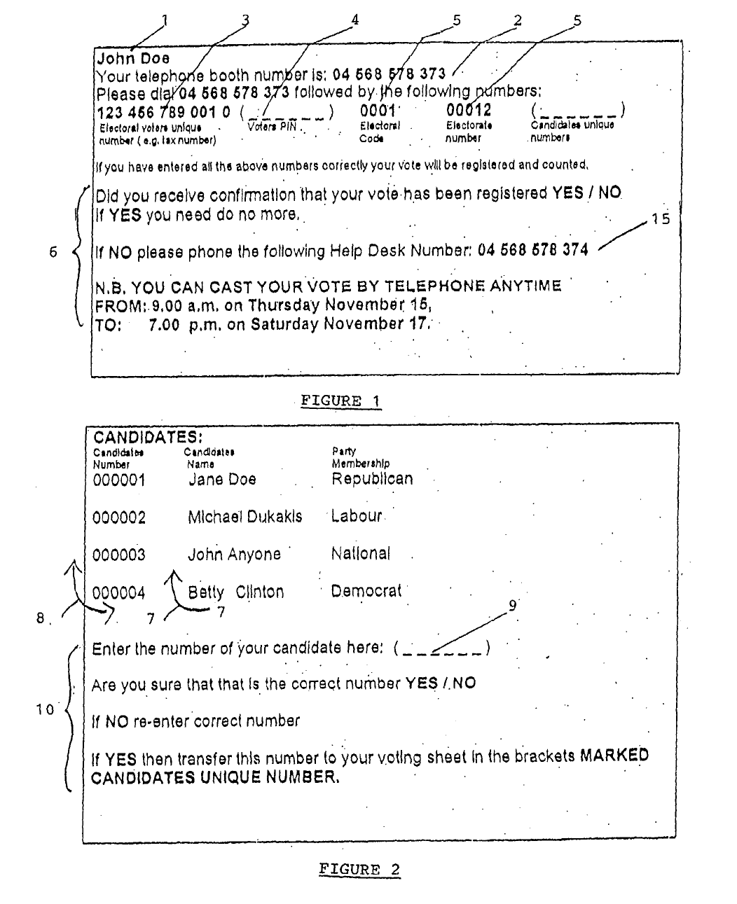

an option form which includes a listing of candidates or options which may be voted for, together with any relevant supplementary information. An example of a suitable form is given as FIG. 2;

a return envelope for the return of documentation which may be used in the event that a recount is required;

under separate cover, and after the initial documentation has been posted, but prior to election date, a voter PIN number.

By way of specific example a voter (John Doe) receives at some time prior to election day, a mail out including the Forms of FIGS. 1 and 2. The form of FIG. 1 provides:

the voter name, 1;

the specified address to which voter information is to be sent 2, in this case a telephone number;

the voter unique signal or code 3;

a space for the subsequent addition of a PIN number 4;

electoral information 5;

voter information, 6;

The form of FIG. 2 provides:

a list of options for voter selection, 7. In this case the options are candidates, but it is envisaged as within the scope of the invention that the options may be of any form, eg choices in a referendum;

unique signal or code identifiers for each candidate 8;

a space for the voter to record the preferred candidate signal or code 9;

voter information 10.

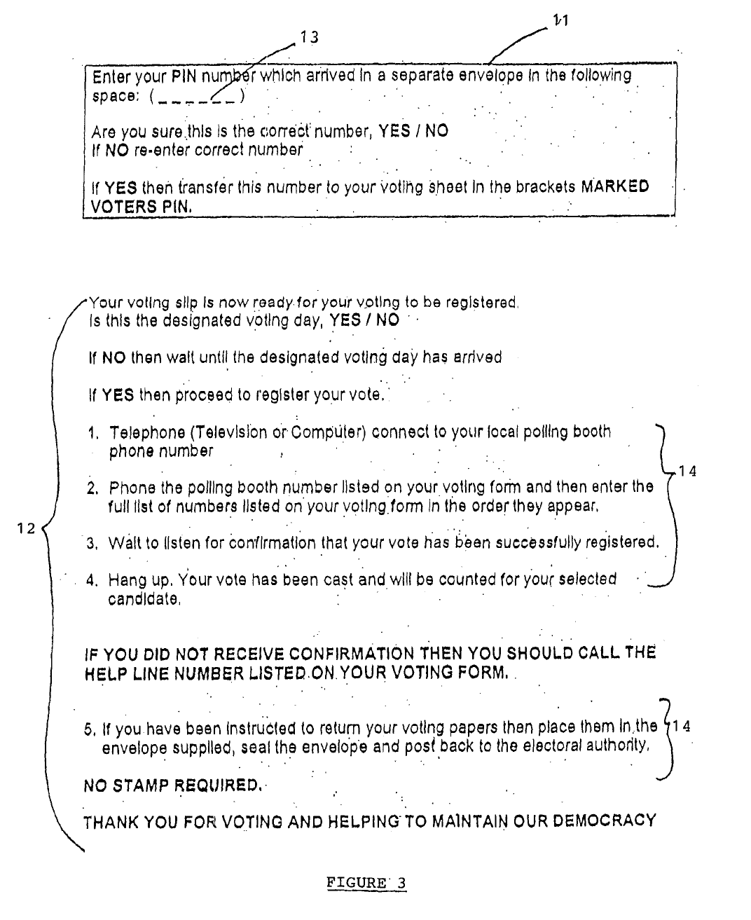

Subsequent to the receipt of the above forms a second mail out supplies the voter with information as shown in FIG. 3.

In this embodiment of the invention FIG. 3 is a combined form 11, and set of instructions for voting day 12.

In the form 11, the voter is notified of its allocated PIN number (supplied in a separate envelope), and a space 13, in which to record this number. In the information portion 12, instructions 14, for voting day itself are provided.

The voter can summarise all the information required for voting, on the form of FIG. 1, and in one option of the invention this form may subsequently be returned to the electoral authorities for use in a recount, or as required.

The voter is then instructed to connect to the designated telephone number, and enter both its identifying signal or code and linked PIN number, and then the preferred candidate signal or code. The voter then waits to receive confirmation that the information has been successfully processed, and disconnects from the address. Should the voter have incorrectly entered the identifying signal or code and linked PIN number it will receive a response prompting re-entry of the code and PIN. Should there be any error in transmission of the data, so that the required confirmation is not received, the voter is referred to the help desk number 15, given on form of FIG. 1.

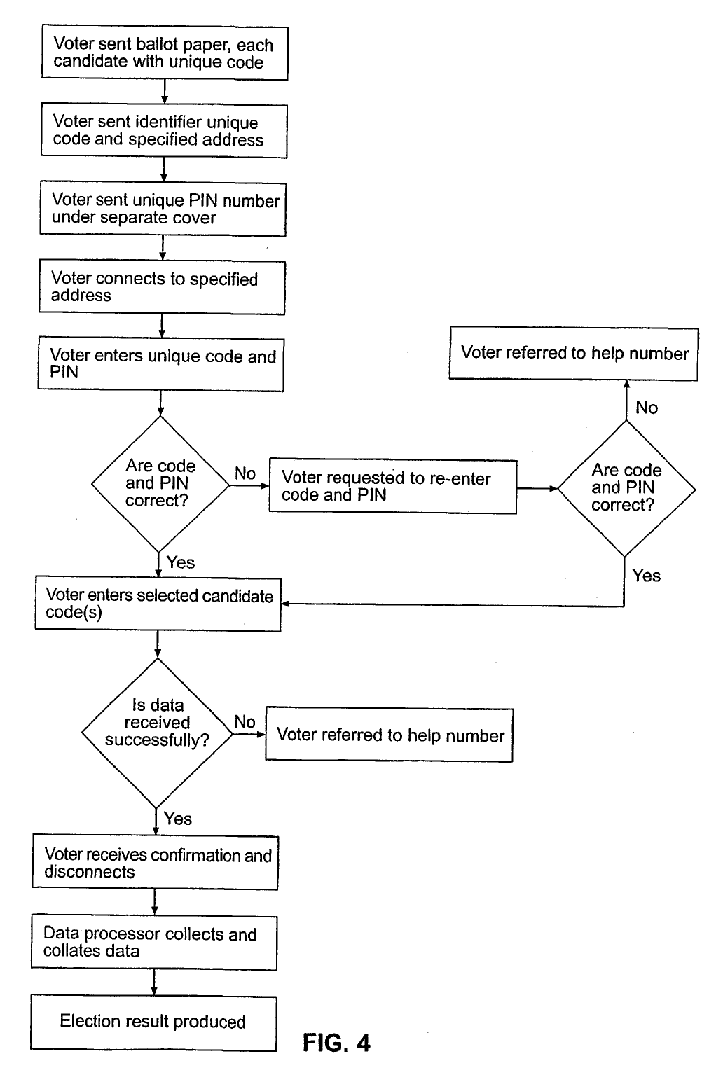

A flow chart describing the sequence of events of the method of the invention is described in FIG. 4.

It will be appreciated that various departures and modifications may be made on the aforementioned example without departing from the scope of the invention.

1. A method of collecting and collating information data the steps of:
a) providing each user with an option or question paper where each option or question has a unique transmittable signal or code;
b) assigning each user with a unique transmittable signal or code;
c) assigning each user a specified address for receiving information to be transmitted by the user by any telecommunications means, or any other means for the transmitting and/or receiving of any signal or code;
d) instructing the user to connect to the said specified address and enter the user signal or code, and signal or code or signals or codes for the selected options or questions, (the data);
e) receiving the entered user data; and
f) processing and/or collating some or all of the user data.

2. A method of voting including the steps of:
a) providing each voter with an option paper wherein each option has a unique transmittable signal or code;
b) assigning each voter a unique transmittable signal, code, or identifier;
c) assigning each voter a specified address for receiving information to be transmitted by the voter by any telecommunications means, or any other means for the transmitting and/or receiving of any signal or code;
d) instructing the voter to connect to the said specified address and enter the voter signal or code, and signal or code or signals or codes for the selected option or options (the data);
f) receiving the entered voter data and; and
g) processing and/or collating some or all of the voter data.

3. The method of either claim 1 or claim 2 wherein the user or voter is provided with a unique transmittable PIN number which must be entered in addition to the unique user or voter transmittable signal or code.

4. The method of any one of the preceding claims wherein the user or voter data is processed by a centralised computer data processing system.

5. The method of any one of the preceding claims wherein after entering all of the user or voter data the user or voter receives a response confirming that the data has been successfully processed and the user or voter may disconnect from the receiving address.

6. The method of any one of the preceding claims wherein if there is incorrect matching of the user or voter unique transmittable PIN number with the unique transmittable user or voter signal or code the user or voter receives a response requesting the re-entry of the unique transmittable user or voter signal or code and the unique transmittable PIN number.

7. The method of any one of the preceding claims wherein all data entered by a user or voter is invalidated if the user or voter attempts to connect to the specified address more than once for the purpose of re-entering selected options.

8. The method of any one of claims 1, 3, 4, 5, 6 or 7 wherein at least one summary of some or all of the processed and collated user data and/or selected options is produced.

9. The method of any one of claims 2, 3, 4, 5, 6 or 7, wherein at least one summary of some or all of the processed and collated voter data and/or selected options is produced.

10. The method of any one of the preceding claims in which the user or voter signal or code, and the signal or code, or signals or codes for the selected option or options are entered such as to embrace the selection interactively, manually or via fixed or dynamically allocated means and processes.

11. The method according to any one of the preceding claims in which the user or voter data and selected options are received and recorded manually, interactively, and/or via any automated process.

12. The method of any one of the preceding claims wherein the telecommunication means is a telephone and the specified address is a telephone number.

13. The method of any one of claims 1 to 11 wherein the telecommunication means is the internet by way of computer, internet enabled phone or interactive TV access, and the specified address is an email address, or website or other suitable receiving site.

14. The method of any one of claims 1 to 11 wherein the telecommunication means is networking-enabled phones and the specified address is a unique address made available by the service provider.

15. The method according to any one of claims 1 to 11 wherein the telecommunications means is a voice activated computer adapted to communicate the voice activated selected option to the specified receiving address which may be an email address, website or other suitable receiving site.

16. The method according to any one of claims 1 to 11 wherein the means for the transmitting and/or receiving of any signal or code includes a card, chip or transponder based process inclusive of an appropriate transmitting and/or receiving process.

17. The method according to any one of the preceding claims when used in association with any previously known system for voting or for the collection and collation of data.

18. The method according to any one of the preceding claims where more than one telecommunications means or any other means for the transmitting and receiving of any signal or code is used.

19. A telecommunications system in association with a data processing system which is networked and adapted to perform the method of any one of the preceding claims.

20. A method for collecting and collating information or voting substantially as hereinbefore described with reference to the accompanying drawings.
